(19) United States
(12) Patent Application Publication
(10) Pub. No.: US 2016/0028589 A1
(43) Pub. Date: Jan. 28, 2016

(54) DATA LOOP DETECTION

(71) Applicant: HEWLETT-PACKARD DEVELOPMENT COMPANY, L.P., Houston,, TX (US)

(72) Inventor: Venkatavaradhan Devarajan, Bangalore (IN)

(21) Appl. No.: 14/777,423

(22) PCT Filed: Jun. 14, 2013
(86) PCT No.: PCT/US2013/045875

§ 371 Date: Sep. 15, 2015

(30) Foreign Application Priority Data
Mar. 15, 2013 (IN) 770/DEL/2013

(51) Int. Cl. H04L 12/24; H04L 12/935; H04L 29/12; H04L 12/705

(52) U.S. Cl. CPC H04L 41/12; H04L 45/18; H04L 49/30; H04L 61/6022

(57) ABSTRACT

Data loop detection can include receiving, from a network controller, a forwarding rule at a designated network device, forwarding a loop-detect unit, via the designated network device, utilizing the received forwarding rule, and determining if the loop-detect unit is received by the designated network device.

### BACKGROUND

A data loop can be caused when data is continuously transferred within a network without being transferred to a particular destination (e.g., end point). For example, forwarding rules assigned to network devices (e.g., routers, switches) can be conflicting (e.g., incorrect). That is, forwarding rules can send units (e.g., frames, packets) within a number of network switches without transferring the data units to a particular destination. A data loop can consume network resources (e.g., bandwidth) by continuously transferring data units among network devices within the network.

### BRIEF DESCRIPTION OF THE DRAWINGS

FIG. 1 illustrates a diagram of an example of a data loop detection system according to the present disclosure.

FIG. 2 illustrates a flow diagram for an example of a data loop detection process according to the present disclosure.

FIG. 3 illustrates a flow diagram for an example of a method for data loop detection according to the present disclosure.

FIG. 4 illustrates a diagram of an example of a computing device according to the present disclosure.

### DETAILED DESCRIPTION

A network can include a number of network devices (e.g., switches, routers, etc.) that are communicatively coupled to a network controller (e.g., computing device instructing the number of network devices on how to transfer data units). The network controller can determine a number of forwarding rules (e.g., software instructions to designate an out-port for a particular destination address) for each of the number of network devices. Incorrect forwarding rules can cause a data loop (e.g., continuous sending of data units within a network, data units that return to a particular network device) within the network. An example data loop can occur when a network device sends a data unit and the data unit returns to the sending network device. In this example, if the forwarding rule set (e.g., multiple forwarding rules to send a data unit from a source to a destination) for the data unit stays the same, the data unit will continue to return to the sending network device causing a “loop” among a number of network devices involved in sending and/or receiving the data unit. Data loops can cause an unnecessary draw in bandwidth of the network. In some cases the data loops can be undetected by the network devices.

Each of the network devices can send a loop detection (“loop-detect”) unit (e.g., loop-detect frame), which, in some examples can include a designated source address. A determination can be made as to whether the loop-detect unit returns to the network device that sent the loop-detect unit. If the network device that sent the loop-detect unit receives the loop-detect unit then the network device can send the loop-detect unit and/or a corresponding forwarding rule set to the network controller for analysis. The network controller can use the received loop-detect unit to determine if there is a data loop and eliminate the data loop by changing a number of forwarding rules for a number of the network devices.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

As used herein, “a” or “a number of” something can refer to one or more such things. For example, “a number of network devices” can refer to one or more network devices.

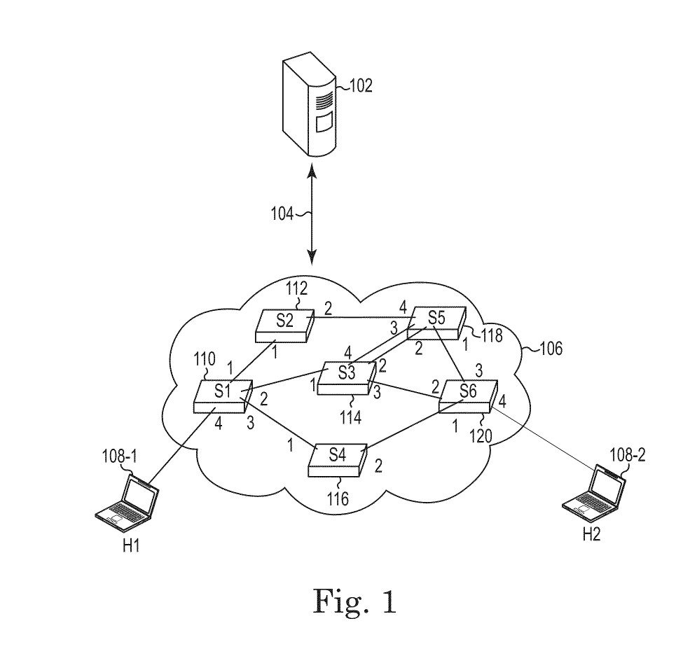

FIG. 1 illustrates a diagram of an example of a data loop detection system 100 according to the present disclosure. The data loop detection system 100 can include features of a software-defined network system (e.g., OpenFlow communications protocol). For example, the data loop detection system 100 can include a network controller 102 (e.g., OpenFlow Controller, Network Administrator). The network controller 102 can be a computing device that is configured to send and/or receive communication via a communication link 104 with a number of network devices within a network 106.

The network controller 102 can include topology information relating to the network 106. Topology information can include information relating to a number of network devices (e.g., switches, routers, etc.). For example, the topology information can include information relating to the connecting and/or capabilities of the network devices 110, 112, 114, 116, 118, 120 within the network 106. The network 106 can include a greater number or fewer number of network devices depending on a particular application.

The topology information can include information relating to network device connections within the network 106. Network device connections can be communication links (e.g., wireless links, Ethernet links) that can communicatively couple the network devices within the network. Each of the network devices can include a particular number of ports (e.g., switch ports) to communicate with other network devices. For example, switch (S1) 110 can have four ports labeled 1, 2, 3, 4. Each of the four ports can be utilized by switch (S1) 110 to communicate with a different network device and/or computing device. For example, port 4 on switch (S1) 110 can be utilized to communicate with a computing device of a host (H1) 108-1. In another example, port 1 on switch (S1) 110 can be used to communicate with port 1 on switch (S2) 112.

Data units can be transferred to various network devices (e.g., switches) within the network 106 based on a forwarding rule (e.g., forwarding rule set). For example, a data unit can be forwarded from the host (H1) 108-1 computing device to switch (S1) 110 utilizing port 4. In this example, switch (S1) 110 can have a forwarding rule that includes transferring data units from the computing device of host 1 (H1) 108-1 utilizing port 2 to port 1 of switch (S3) 114.

Each of the network devices within the network 106 can receive a particular forwarding rule from the network controller 102 based on a source address (e.g., sender address) and a destination address (e.g., receiver address) of the data unit. The source address and the destination address of the data unit can be considered a sender/receiver pair. That is, each data unit can include an address for the sender and an address for the receiver of the data unit and both can utilized together as a pair for the network controller 102 to determine the particular forwarding rule for a number of network devices.

The source address and destination address can be a media access control (MAC) address. For example, a source address can identify a source (e.g., sending device) of the data units. In another example, the destination address can identify a destination (e.g., receiving device, destination device) of the data units. The source address and the destination address can be located in a header of the data units. Each of the number of network devices within the network 106 can analyze the header of the data units and determine the source address and destination address of the data units. Based on the determined source address and destination address of the data units, each of the number of network devices can transfer (e.g., forward, send) the data unit to a different network device and/or computing device connected to the network 106.

The network controller 102 can create new forwarding rules for a particular source address and destination address that does not currently exist and/or that is incorrect. For example, the network controller 102 can receive notification from switch (S1) 110 that a data unit with a header that includes a source address and/or destination address has no existing forwarding rule. In this example, the network controller 102 can determine a forwarding rule set and designate a forwarding rule for each of the number of network devices within the network 106 to correctly deliver the data unit to the correct destination address.

Correctly delivering a data unit from host (H1) to host (H2) can include a particular forwarding rule set (e.g., plurality of forwarding rules, forwarding rules for multiple network devices). The rule set can include a designated forwarding rule for each individual network device. For example, the forwarding rule set for a destination of the computing device of host (H2) 108-2 can include a forwarding rule for each of the network devices: switch (S1) 110, switch (S3) 114, and switch (S6) 120. In this example forwarding rule set, switch (S1) 110 can receive a data unit from host (H1) 108-1 via port 4 on switch (S1) 110 and according to the forwarding rule, switch (S1) 110 can forward the received data unit out-port 2 on switch (S1) 110 to port 1 of switch (S3) 114. The forwarding rule for switch (S3) 114 when receiving a data unit with the destination address for the computing device of host (H2) 108-2 can include sending the data unit out-port 3 of switch (S3) 114 to port 2 of switch (S6) 120. The forwarding rule for switch (S6) 120 when receiving a data unit with the destination address for the computing device host (H2) 108-2 can include sending the unit from port 4 of switch (S6) 120 to the computing device of host (H2) 108-2.

An incorrect or miscalculated forwarding rule within the forwarding rule set can cause a data loop. The data loop can occur when a data unit is forwarded among a number of network devices without being delivered to a computing device coupled to the network 106. For example, a data loop can occur when a forwarding rule set sends a data unit back to a sending network device. As described herein, each network device within the network 106 can have a forwarding rule that corresponds to a forwarding rule set for transferring data from a source to a destination. The forwarding rule for a number of network devices can be incorrect for sending a data unit from a particular source to a particular destination.

In some instances, an incorrect forwarding rule may have been designated to switch (S6) 120 and can cause a data loop within the network 106. For example, the forwarding rule for switch (S6) 120 can be an instruction to send a data unit out of port 3 of switch (S6) 120 to port 1 of switch (S5) 118 when receiving a data unit with a destination address for the computing device of host (H2) 108-2. This forwarding rule for switch (S6) 120 will send the data unit to switch (S5) 118 and the forwarding rule for switch (S5) 118 can be to send the data unit to switch (S3) 114 via port 2 or port 3 of switch (S5) 118. In this example, the data unit can be continually sent from switch (S3) 114 to switch (S6) 120 and to switch (S5) 118 without being delivered to the destination address (e.g., host (H2) 108-2) causing a data loop between: switch (S3) 114, switch (S6) 120 and switch (S5). The data unit in this data loop can be continuously sent among the three network devices (e.g., switch (S3) 114, switch (S6) 120 and switch (S5)) without being delivered to the computing device of host (H2) 108-2.

The forwarding rule set can be tested utilizing a loop-detect unit (e.g., loop-detect frame) to determine if the data units are correctly delivered to the correct destination address and do not produce a data loop. The loop-detect unit can include a data unit with a header that includes a loop-detect media access control (MAC) address. The loop-detect MAC address can be used similarly to the source address of a data unit that is being forwarded through the network 106. For example, the loop-detect MAC address can be included within the header of the loop-detect unit. Each of the network devices within the network 106 can analyze the loop-detect unit and retrieve the loop-detect MAC address to determine that the received unit is the loop-detect unit.

The loop-detect unit can be utilized to test each of a number of forwarding rules determined by the network controller 102. For example, the loop-detect unit can be sent to switch (S1) 110 with the loop-detect MAC address as the source address and a destination address for the computing device of host (H2) 108-2. In this example, switch (S1) 110 can operate based on forwarding rules for the computing device of host (H2) 108-2 previously received from the network controller 102. That is, the switch (S1) 110 can use a forwarding rule associated with the destination address for the computing device of host (H2) 108-2.

After sending the loop-detect unit to a different network device (e.g., switch (S4) 116, switch (S3) 114, switch (S2) 112), switch (S1) 110 can analyze received units to determine whether the loop-detect unit that includes the loop-detect MAC address is received by switch (S1) 110. If switch (S1) 110 receives the loop-detect unit that includes the loop-detect MAC address, an advertisement (e.g., data unit including analysis information) and/or the loop-detect unit can be sent to the network controller 102 to alert the network controller 102 that a data loop for the destination address of the computing device for host (H2) 108-2 is occurring. That is, the forwarding rule for data units with a destination address for the computing device of host (H2) 108-2 are not correctly being delivered to host (H2) 108-2, but are continually being sent between network devices within the network 106. For those examples in which the network 106 is a Layer 2 network, a looping unit (e.g., frame) may loop continuously as Layer 2 generally does not support time to live (TTL) for frames. If the loop-detect unit is not received by the switch (S1) 110, then it can be determined that the network rule for the destination address of the computing device of host (H2) 108-2 does not loop back to switch (S1) 110.

The data loop between switch (S3) 114, switch (S6) 120 and switch (S5) can be detected by sending the loop-detect unit with the loop-detect MAC address out of port 3 to port 2 of switch (S6) 120. Switch (S6) 120 would then send the loop-detect unit out of port 6 to port 1 of switch (S5) 118. When switch (S5) 118 sends the loop-detect unit from port 2 to port 2 on switch (S3) 114 the loop-detect MAC address can be analyzed by the switch (S3) 114 to determine that there is a data loop within the network 106 when the destination address is the computing device of host (H2) 108-2. That is, switch (S3) 114 can analyze the header and determine if the source address is the loop-detect MAC address. If the source address is the loop-detect MAC address the switch (S3) 114 can send the loop-detect unit to the network controller 102.

The network controller 102 can utilize the received loop-detect unit to determine information regarding the data loop. For example, the network controller 102 can determine the number of network devices involved in the loop and which of the network devices have an incorrect forwarding rule. In the example data loop, the network controller 102 can determine that switch (S6) has an incorrect forwarding rule. The network controller 102 can change the forwarding rule for switch (S6) from sending the data unit out of port 3 to sending the data unit out of port 4 when the destination address is the computing device of host (H2) 108-2.

Each of the number of network devices can include a flow match condition for a number of data transfers. The number of data transfers can include the forwarding rule sets for data transfers between a first host (e.g., host (H1) 108-1) and a second host (e.g., host (H2) 108-2). The forwarding rule sets can be used to designate a particular port on each of the number of network devices to receive and/or send a data unit with a particular source address and a particular destination address. For example, a particular forwarding rule set can be used to designate a particular path between the computing device of host (H1) 108-1 and the computing device of host (H2) 108-2. Each network device within the network 106 can have a designated in-port and a designated out-port for the forwarding rule set. For example, switch (S1) 110 can have port 4 be a designated in-port for the particular forwarding rule set. In addition, switch (S1) 110 can have port 2 be a designated out-port for the particular forwarding rule set.

The flow match condition can be used without generating a fabricated data unit (e.g., loop-detect unit). That is, the flow match condition analyzes packets that are sent and received by host computing devices (e.g., computing device of host 1 (108-1)). Utilizing the flow match condition, each of the number of network devices can determine if a received data unit is possibly sent from an incorrect rule set and/or is a data unit that is in a data loop. That is, if one of the number of network devices receives a data unit in a non-designated port, the data unit can be sent to the network controller 102. For example, switch (S1) 110 can receive a data unit in-port 1 with a header that includes a source address of the computing device of host (H1) 108-1 and a destination address of the computing device of host (H2) 108-2. In this example, the designated port can be port 4 and since the data unit was received in-port 1 the switch (S1) 110 can send the data unit to the network controller 102. The network controller 102 can determine if the data unit is involved in a data loop or if there was a different reason why the data unit was received in a non-designated port.

The loop-detect unit and flow match condition can be utilized to detect data loops within the network 106. The loop-detect unit can be used in combination with the flow match condition or separately and distinctly from the flow match condition. Once a data loop is detected and/or determined to exist within the network 106 the network controller 102 can send updated (e.g., different, new) forwarding rules to a number of network devices to eliminate the data loop.

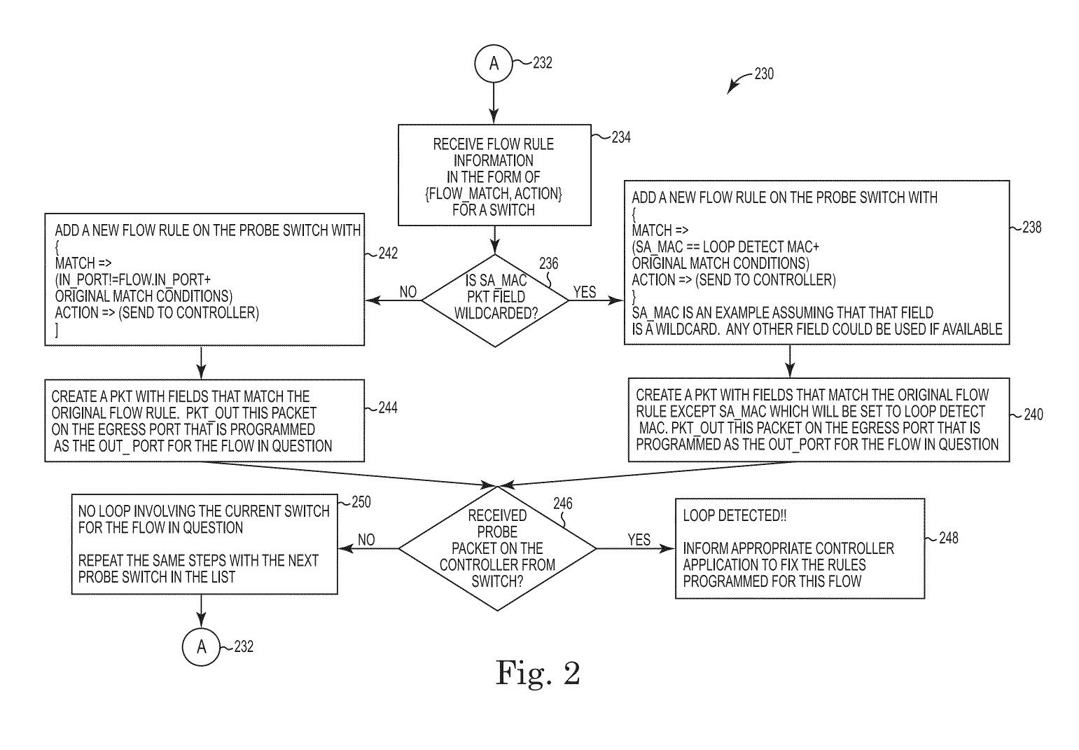

FIG. 2 illustrates a flow diagram for an example of a data loop detection process 230 according to the present disclosure. The data loop detection process 230 can start at position A 232. At box 234 a network device can receive flow rule information in a particular form (e.g., {flow_match, action}). The flow rule information can include an instruction of a designated in-port (e.g., receiving port) for a particular source address. For example, switch (S1) can have a flow rule to receive data units in-port 4 when the source address is from the computing device of host (H1) 108-1. In this example, it can be determined that there is a problem (e.g., data loop, etc.) if switch (S1) receives a data unit in-port 1 with a source address from the computing device of host (H1) 108-1.

At box 236 it is determined whether or not a wildcard value exists within the flow match rule of the received data unit. The wildcard value can be utilized in “LIKE” expressions in structured query language (SQL) protocols. That is, whether or the source MAC address field is wildcarded. If the header does include a wildcard value the process can move to box 238.

At box 238 a flow rule can be added to a particular network device if a loop detection unit is necessary for the flow rule to operate. For example, a flow rule can be added to a particular switch within the network to instruct the particular switch to analyze the header of received data units and if a match of the flow rule occurs to send the data unit to the network controller.

At box 240 a data unit can be created with a header (e.g., information fields) that matches the original flow rule of the data unit other than the source address (e.g., SA_MAC) which can be set to a loop detect address. As described herein, the loop detect address can be used to determine if the data unit returns to the network device that sent the data unit.

If the data unit does not include a wildcard (e.g., source MAC address wildcard) value at box 236 the process can move to box 242. At box 242 a new flow rule on a loop detect unit can be added to a particular network device if the loop detect unit is warranted. For example, a flow rule can be added to a particular switch within the network to instruct the particular switch to analyze the header of received data units and if a match of the flow rule occurs to send the data unit to the network controller.

At box 244 a loop-detect unit can be created with header information (e.g., data fields, destination address) that matches the flow rule of a previously received data unit and matches the flow rule added to the designated network device. The source address of the previously received data unit can be changed to a loop-detect address (e.g., loop-detect media access control (MAC) address) for the loop-detect unit.

At box 246 a determination can be made whether or not the loop-detect unit is received by the designated network device that sent the loop-detect unit. As described herein, a loop-detect unit can be sent by a particular network device that includes a loop-detect address and if the particular network device receives the loop-detect unit that includes the loop-detect address it can be determined that there is a loop within the network.

In cases where the source address is not wildcarded, the loop-detect unit can be identified based on the source address of the data unit and the received in-port of the data unit. That is, if the in-port is a designated port for the the source address it can be determined that there is not a data loop. If the in-port is not the designated port for the source address it can be determined that there is a data loop within the network

If the loop-detect unit is received by the sending network device the process can move to box 248 and the network controller can be notified. If the loop-detect unit is not received by the sending network device then the process can move to box 250 and it can be determined that there is not a loop for the particular forwarding rule. The process can be repeated a number of times to test various forwarding rules for a variety of destination addresses connected to the network.

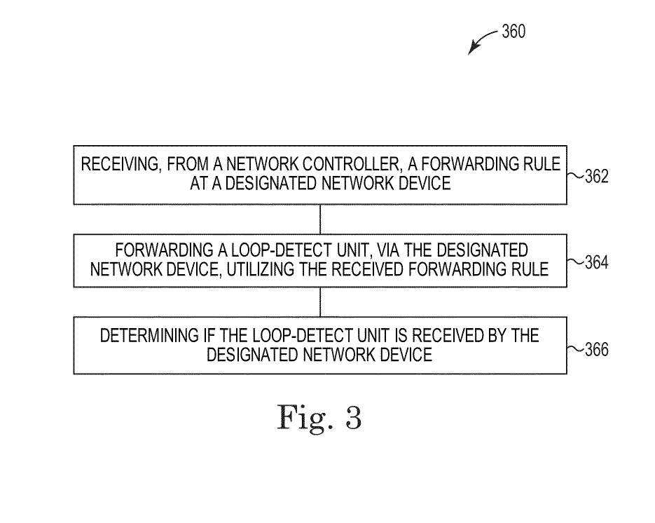

FIG. 3 illustrates a flow diagram for an example of a method 360 for data loop detection according to the present disclosure. The method 360 can be utilized to detect a data loop within a network.

At box 362 the method 360 can include receiving, from a network controller, a forwarding rule at a designated network device. The forwarding rule can be part of an overall forwarding rule set for a number of data transfers between computing devices coupled to a network. The network controller can be communicatively coupled to each of the number of network devices. The network controller can include information relating to the network. For example, the network controller can include the network topology (e.g., a number of network devices, connections between the number of network devices, capabilities of the number of network devices, network architecture, etc.).

The network controller can designate a number of forwarding rules to each of the number network devices. The forwarding rules can be based on an overall forwarding rule set for transferring data units from a first host computing device to a second host computing device. The network controller can create forwarding rules if there is not an existing forwarding rule and/or can change the forwarding rules if there is an incorrect forwarding rule.

At box 364 the method 360 can include forwarding a loop-detect unit, via the designated network device, utilizing the received forwarding rule. The loop-detect unit can be a probe data unit that can include unit information that is identical to a recently received data unit and is altered to include a source address that is a loop-detect address. The loop-detect unit can follow the same forwarding rule set as the data unit with the same unit information.

At box 366 the method 360 can include determining if the loop-detect unit is received by the designated network device. The loop-detect unit can be used to determine if there is a data loop within the network. If the loop-detect unit is received by the network device that sent the loop-detect unit, it can be determined that there is a data loop within the network. If the network device receives the loop-detect unit the network device can send the received loop-detect unit to the network controller. The network controller can use the loop-detect unit to determine where the data loop is located within the network. That is, the network controller can determine a number of network devices that are included in the data loop and determine a forwarding rule that should be change to eliminate the data loop.

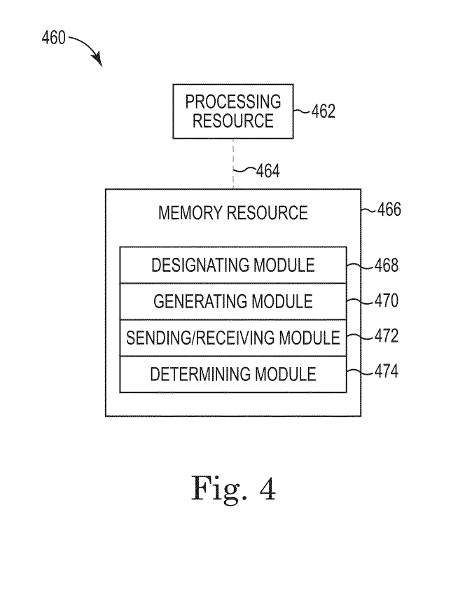

FIG. 4 illustrates a diagram of an example of a computing device 460 according to the present disclosure. The computing device 460 can utilize software, hardware, firmware, and/or logic to perform a number of functions described herein.

The computing device 460 can be any combination of hardware and program instructions configured to share information. The hardware, for example can include a processing resource 462 and/or a memory resource 466 (e.g., computer-readable medium (CRM), machine readable medium (MRM), database, etc.) A processing resource 462, as used herein, can include any number of processors capable of executing instructions stored by a memory resource 466. Processing resource 462 may be integrated in a single device or distributed across multiple devices. The program instructions (e.g., computer-readable instructions (CRI)) can include instructions stored on the memory resource 466 and executable by the processing resource 462 to implement a desired function (e.g., compare a header of received data to the flow match condition to determine a utilized port for the received data and a sender/receiver pair, etc.).

The memory resource 466 can be in communication with a processing resource 462. A memory resource 466, as used herein, can include any number of memory components capable of storing instructions that can be executed by processing resource 462. Such memory resource 466 can be a non-transitory CRM. Memory resource 466 may be integrated in a single device or distributed across multiple devices. Further, memory resource 466 may be fully or partially integrated in the same device as processing resource 462 or it may be separate but accessible to that device and processing resource 462. Thus, it is noted that the computing device 460 may be implemented on a user and/or a participant device, on a server device and/or a collection of server devices, and/or on a combination of the user device and the server device and/or devices.

The processing resource 462 can be in communication with a memory resource 466 storing a set of CRI executable by the processing resource 462, as described herein. The CRI can also be stored in remote memory managed by a server and represent an installation package that can be downloaded, installed, and executed. Processing resource 462 can execute CRI that can be stored on an internal or external memory resource 466. The processing resource 462 can execute CRI to perform various functions, including the functions described with respect to FIGS. 1, 2, and 3. For example, the processing resource 462 can execute CRI to generate a loop-detect unit comprising a loop-detect media access control (MAC) address.

The memory resource 466, as used herein, can include volatile and/or non-volatile memory. Volatile memory can include memory that depends upon power to store information, such as various types of dynamic random access memory (DRAM), among others. Non-volatile memory can include memory that does not depend upon power to store information. The memory resource 466 can be integral, or communicatively coupled, to a computing device, in a wired and/or a wireless manner. For example, the memory resource 466 can be an internal memory, a portable memory, a portable disk, or a memory associated with another computing resource (e.g., enabling CRIs to be transferred and/or executed across a network such as the Internet).

The memory resource 466 can be in communication with the processing resource 462 via a communication link (e.g., path) 464. The communication link 464 can be local or remote to a machine (e.g., a computing device) associated with the processing resource 462. Examples of a local communication link 464 can include an electronic bus internal to a machine (e.g., a computing device) where the memory resource 466 is one of volatile, non-volatile, fixed, and/or removable storage medium in communication with the processing resource 462 via the electronic bus.

The communication link 464 can be such that the memory resource 466 is remote from the processing resource (e.g., 462), such as in a network connection between the memory resource 466 and the processing resource (e.g., 462). That is, the communication link 464 can be a network connection. Examples of such a network connection can include a local area network (LAN), wide area network (WAN), personal area network (PAN), and the Internet, among others. In such examples, the memory resource 466 can be associated with a first computing device and the processing resource 462 can be associated with a second computing device (e.g., a Java® server). For example, a processing resource 462 can be in communication with a memory resource 466, wherein the memory resource 466 includes a set of instructions and wherein the processing resource 462 is designed to carry out the set of instructions.

A number of modules 468, 470, 472, 474 can include CRI that when executed by the processing resource 462 can perform a number of functions. The number of modules 468, 470, 472, 474 can be sub-modules of other modules. For example, the designating module 468 and the generating module 470 can be sub-modules and/or contained within the same computing device. In another example, the number of modules 468, 470, 472, 474 can comprise individual modules at separate and distinct locations (e.g., CRM, etc.).

A designating module 468 can include CRI that when executed by the processing resource 462 can designate a forwarding rule and a flow match condition to each of a number of network devices within a network. The forwarding rule can include forwarding instructions for a particular network device to follow when the particular network device receives a data unit with a particular destination address. The flow match condition can include a designated in-port to receive the data unit with the particular destination address and instructions of a designated out-port for the data unit. The flow match condition can also include instructions to send the data unit to the network controller if the data unit is received from a port other than the designated port.

A generating module 470 can include CRI that when executed by the processing resource 462 can generate a loop-detect unit comprising a loop-detect media access control (MAC) address. The generating module 470 can generate a loop-detect unit that can be a probe data unit that includes information relating to previously received data units. The loop-detect unit can be generated to include a loop-detect address to replace the source address.

A sending/receiving module 472 can include CRI that when executed by the processing resources 462 can send status information to a network controller if the utilized port does not match the designated port for the sender and receiver pair. The sending/receiving module 472 can include CRI that when executed by the processing resources 462 can send the loop-detect unit from the designated network device based on the forwarding rule designated to the first network device. The sending/receiving module 472 can include CRI that when executed by the processing resources 462 can send status information to the network controller if the loop-detect unit is received by the designated network device.

The determining module 474 can include CRI that when executed by the processing resource 462 can determine, via the network controller, if a data loop is occurring within the network based on the status information received from the number of network devices. The determining module 474 can utilize the loop-detect unit and/or the flow match condition data to determine if an inconsistency is a data loop within the network.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method, comprising:
receiving, from a network controller, a forwarding rule at a designated network device;
forwarding a loop-detect unit, via the designated network device, utilizing the received forwarding rule; and
determining if the loop-detect unit is received by the designated network device.

2. The method of claim 1, comprising designating, by the network controller, a port for transferring data units to a particular destination based on the forwarding rule.

3. The method of claim 1, wherein forwarding the loop-detect unit includes forwarding data that includes a loop-detect media access control (MAC) address.

4. The method of claim 3, wherein determining if the loop-detect unit is received includes determining if a received data unit includes the loop-detect MAC address.

5. The method of claim 1, wherein receiving the forwarding rule includes receiving a forwarding rule set for a number of data unit transfers between host computing devices coupled to a network.

6. The method of claim 1, wherein the loop-detect unit includes unit information that is identical to a recently received data unit and the method includes altering the unit information to include a source address that is a loop-detect address.

7. A non-transitory computer-readable medium storing a set of instructions executable by a processor to cause a network device to:
receive a flow match condition, wherein the flow match condition comprises a designated incoming port for a particular data unit associated with a particular sender/receiver pair;
determine an incoming port for a received data unit associated with the particular sender/receiver pair;
compare the incoming port for the received data unit to the flow match condition; and
send a message to a network controller if the incoming port is different than the designated incoming port.

8. The medium of claim 7, wherein the instructions to send the message to the network controller includes instructions to send the received data unit to the network controller.

9. The medium of claim 7, wherein the flow match condition is generated based on a designated path from a first host computing device to a second host computing device via a network that includes the network device.

10. The medium of claim 7, storing instructions to receive a forwarding rule for the particular data unit.

11. The medium of claim 10, wherein the forwarding rule includes instructions to change an out-port for the particular data unit associated with the particular sender/receiver pair to eliminate a data loop.

12. A system for data loop detection, the system comprising:
a network controller comprising computer-readable instructions that are executed by a processing resource to:
generate a loop-detect unit comprising a loop-detect media access control (MAC) address;
send the loop-detect unit, via the network device, based on a forwarding rule;
receive status information from the network device relating to the forwarding rule; and
determine if a data loop is occurring within the network based on the status information received from the network device, wherein the status information includes the loop-detect unit.

13. The system of claim 12, wherein instructions to generate include instructions to generate the loop-detect unit with a particular destination address of a previously received data unit.

14. The system of claim 12, wherein the status information includes the forwarding rule.

15. The system of claim 12, wherein the forwarding rule is based on a network topology.
